(19) United States
(12) Patent Application Publication
(10) Pub. No.: US 2026/0010134 A1
(43) Pub. Date: Jan. 8, 2026

(54) METHOD FOR THE EFFICIENT CONFIGURATION OF CONTROL DEVICES

(71) Applicant: WAGO Verwaltungsgesellschaft mbH, Minden (DE)

(72) Inventor: Thomas HOLM, Bad Salzuflen (DE)

(73) Assignee: WAGO Verwaltungsgesellschaft mbH, Minden (DE)

(21) Appl. No.: 19/259,091

(22) Filed: Jul. 3, 2025

(30) Foreign Application Priority Data
Jul. 3, 2024 (DE) 10 2024 118 846.4

(51) Int. Cl. G05B 17/02

(52) U.S. Cl. CPC G05B 17/02

(57) ABSTRACT

A method for planning and setting up room and building automation approaches. The following steps are carried out by software: analyzing existing building information models for geometric features and associated features of automation approaches; generalizing the geometric features and the associated features of automation approaches in order to determine generalized geometric features and associated generalized features of automation approaches; analyzing a building information model, to be planned, for geometric features; comparing the analyzed geometric features of the building information model to be planned to the generalized geometric features; determining a comparison result; and for a positive comparison result, including associated generalized features of automation approaches for the building information model to be planned, corresponding to the identified geometric features. Software for carrying out the method is also provided.

This nonprovisional application claims priority under 35 U.S.C. § 119(a) to German Patent Application No. 10 2024 118 846.4 which was filed in Germany on Jul. 3, 2024, and which is herein incorporated by reference.

### BACKGROUND OF THE INVENTION

### Field of the Invention

The present invention relates to the field of building automation, and in particular to a method and to software for the efficient configuration of control devices in the planning and setup of room and building automation approaches, using a building information model.

### Description of the Background Art

In the planning of automation approaches for functional buildings and residential buildings, large-scale paper plans and lists derived therefrom have been used in the past. In recent times, digitization has also become increasingly prevalent.

The process of digital building information modeling (BIM) is used for the planning of buildings. In the ideal case, this process provides that all disciplines involved in the planning and construction operate in a shared data system, the building information model. All planning iterations and results are to be stored in this data system, so that multi-disciplinary communication is made possible and errors are reduced.

The modeling of a building in the context of BIM takes place using the “Industry Foundation Classes” (IFC) data model. Each discipline models the discipline-specific results and intermediate results in the IFC data model and transfers them to the BIM manager responsible for the project. The BIM manager combines the various models and identifies planning errors or necessary coordination among the disciplines.

In the discipline of automation engineering, it is also necessary to synchronize the discipline-specific planning process with the BIM process. However, at the present time only portions of the automation system can be depicted in IFC. This includes above all the planning results which have an effect on the 3D space, i.e., result in the installation of the hardware of the automation system in the building.

Following the “Internet of Things” trend, buildings are increasingly being controlled digitally and virtually. However, this requires comprehensive setup and programming of the necessary components of the automation systems, which generally do not take place until their hardware is installed in the building.

### SUMMARY OF THE INVENTION

It is therefore an object of the present invention, to use software to assist in the planning process in room and building automation, thus simplifying in particular the setup and programming of digital and virtual control of a building.

In particular, the above-mentioned object is achieved in an example by a method for planning room and building automation approaches, comprising the following steps which are carried out by software: (a) analyzing existing building information models for geometric features and associated features of automation approaches; (b) generalizing the geometric features and the associated features of automation approaches in order to determine generalized geometric features and associated generalized features of automation approaches; (c) analyzing a building information model, to be planned, for geometric features; (d) comparing the analyzed geometric features of the building information model to be planned to the generalized geometric features, and determining a comparison result; and (e) for a positive comparison result, including associated generalized features of automation approaches for the building information model to be planned, corresponding to the identified geometric features.

By use of the method, a basic plan of room and building automation approaches may be automatically created for a building to be newly planned. The method initially analyzes existing building information models for geometric features and associated features of automation approaches (step a). This results in an association of geometric features of the building with features of automation approaches that are already specifically planned. For example, if windows with electric blinds are planned for an office building, the software recognizes these geometric features and determines the associated blind control approach, for example a corresponding controller, a wind monitor, a power supply for the controller, multiple switches, lines to the electric blinds, etc.

When several such associations of geometric features with associated features of automation approaches have been found, in particular during an analysis of a plurality of building information models, the software can recognize regularities and generalize the geometric features and the associated features of automation approaches (step b). In the above example, the pair of features could be generalized, for example, in such a way that a window with an electric blind in each case requires an on/off switch and lines for supplying power to the blind. However, a controller, a wind monitor, a power supply for the controller, etc., are not necessary for each window, since only one may possibly be needed for the entire building. Such features could then be characterized as optional features.

In a further step of the method, the software analyses the BIP building model to be planned for geometric features (step c). Geometric features are thus identified in the BIP building model to be planned. For example, rooms, doors, windows, story levels, utility rooms, etc., could be automatically identified. When the geometric features of the BIP building model to be planned are analyzed, they are compared to the generalized geometric features, and a comparison result is determined (step d).

For a positive comparison result, i.e., when geometric features are found in the BIP building model to be planned which correspond to the generalized geometric features, associated features of automation approaches are assigned to the BIP building model to be planned, corresponding to the identified geometric features (step e). In this way, the software can automatically carry out basic planning of automation approaches for a new BIP building model. It is then only necessary to supplement or individually configure the planning if desired. This method significantly shortens the planning time for the building automation, and reduces errors.

In the above example, if the software in the BIP building model to be planned recognizes, based on geometric features, that a window with electric blinds is planned, it will automatically include an on/off switch and lines for supplying power to the blind for this window and enter them into the BIP building model.

The software for carrying out the method preferably includes a neural network, a cognitive machine, or a combination thereof. The above-mentioned steps may be carried out in a particularly simple and flexible manner by use of such software elements. In particular, the software can learn and adapt to BIP building models or automation approaches that change over time.

The step of analyzing existing building information models for geometric features preferably includes identification of a building structure. Such building structures may include certain types of rooms, areas of rooms, story levels, building parts, etc.

The step of recognizing generalized geometric features in a building information model to be planned preferably includes identification of a building structure.

The geometric features or the generalized geometric features preferably include three-dimensional artifacts. Thus, for example, a door, a window, and a suspended ceiling may be recognized based on the three-dimensional shape in the building information model.

The building information models are preferably created in standard Industry Foundation Classes (IFC). A multi-disciplinary standard for the data exchange is thus used which enables cooperation of the planning of room and building automation approaches with other disciplines.

The method preferably also includes the step of downloading a stock configuration of an automation approach of an existing building. It is thus possible to rely not only on automation approaches that are already planned and present in a building information model, but also on buildings that are already implemented with their automation approaches.

For the downloading, hardware on which the software for carrying out the method runs is preferably connected to one or more stock control devices of the existing building. Thus, for example, the configurations and control programs of control systems that are already installed may be read out and reused for new building plans.

The method described above preferably also can include the following steps: recommendation to a user of the generalized features of automation approaches that are assigned to the building information model to be planned; and acceptance of the recommended automation approach by the user.

The automation planner may thus be involved in the automatic planning, in which the planning process runs much more quickly and efficiently due to the generalized features of automation approaches that are recommended by the software and assigned to the building information model to be planned. The planner only has to accept or reject the recommendations of the software.

The method can also include the step of manually adapting the features of the automation approach by the user. The software also allows the user to manually adapt the features of the automation approach, for example, to plan control logic systems that are individual for each room.

The method can also include the step of exporting the supplemented building information model as an IFC model to a BIM manager.

The method can also include the step of setting up embodiments of artifacts of the building automation that are installed in a building, based on the configuration of artifacts that is included in the building information model.

The above-mentioned mentioned object is further achieved by software for carrying out the method described above. The software can be provided on a non transitory computer-readable medium, for example, a computer, cdrom, ram, etc., that causes one or more processors to perform the operations

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a flow chart of an example of the method for planning room and building automation approaches;

FIG. 2 shows a structure diagram of an example of software for carrying out the method;

FIG. 3A shows a 3D model of a building of a building information model;

FIG. 3B shows a sectional 3D model of a building of a building information model;

FIG. 4 shows a sectional 3D model of a building of a building information model with a placed artifact of the building automation; and

FIG. 5 shows a planning result for an identified structure.

### DETAILED DESCRIPTION

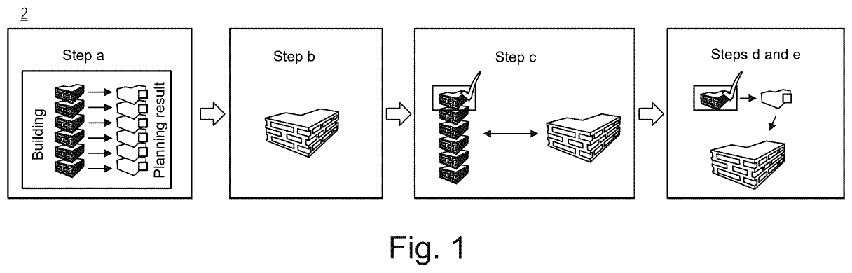

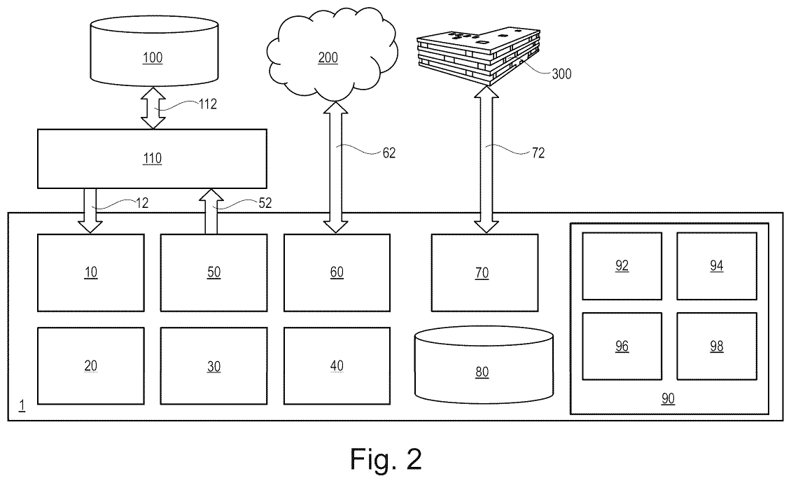

FIG. 1 illustrates a flow chart of an example of the method 2 for planning room and building automation approaches. The method 2 comprises the following steps, which may run essentially automatedly using software, and which result in basic planning of the automation engineering of a building to be planned, which with regard to its geometric structures has already been planned using BIM, and which is present as a building information model 100 (see FIG. 2).

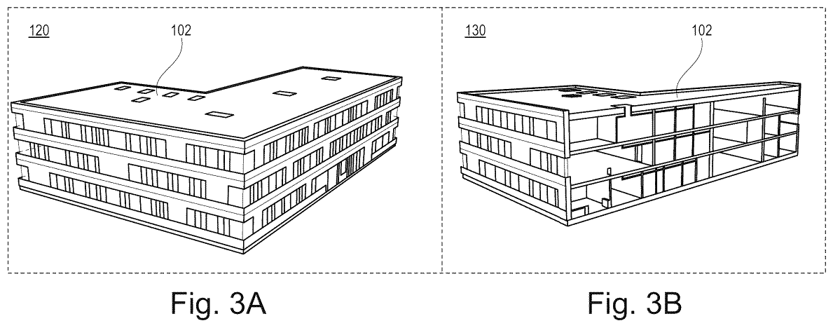

For creation of a knowledge base, the method requires the greatest possible number of building models that have been planned using BIM, and whose building model is digitally present as a building information model. The building geometry as well as the automation engineering for same are planned in detail in these building models. Examples of views 120 and 130 of a 3D building model 102 of a building information model are illustrated in FIGS. 3A and 3B, respectively.

In the case that the building model 102 includes the geometry, but the planned automation engineering is modeled only according to its structure, it is possible to download features, logic, and other configuration data from the corresponding existing building if they are present. For this purpose, hardware, such as a computer on which the software 1 for carrying out the method runs, for example an engineering program, is connected to one or more stock control devices of the existing building 300 (see FIG. 2). The stock configuration may then be downloaded, as indicated by the arrow 72 in FIG. 2, and added to the building information model 100.

Specifically, the computer on which the engineering program 1 runs is connected to one or more stock control devices that are present in the same network or in multiple separate networks. The computer itself may be situated either in the same network or in a different network. The computer then scans the network of the building for network users. The engineering program can thus determine the stock control devices that are present at all and that are accessible via data technology. From the accessible control devices, their stock configuration, for example the logic stored there in the form of control programs, may then be automatically downloaded and added to the corresponding artifact (element) of the control device in the building information model 100.

The existing building information models 100 are analyzed for geometric features and associated features of automation approaches in a first method step (step a). The geometric features and the associated features of automation approaches may be referred to as sample pairs.

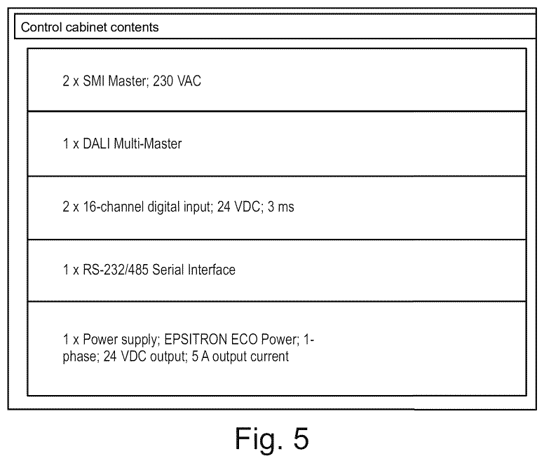

In an example of a sample pair, a segment of the building made up of two windows with roller blinds, a door, walls, and a suspended ceiling could be identified. For this geometric feature, the automation planner in many cases has provided, among other things, a control cabinet in the suspended ceiling of the segment. The control cabinet, as illustrated in FIG. 5, in many cases has been equipped with a similar building structure, with two designated SMI masters (SMI master; 230 VAC), a DALI master (DALI Multi-Master), two 16-channel digital inputs (16-channel digital input; 24 VDC; 3 ms), a serial interface (RS-232/485 serial interface), and a network component (power supply; EPSITRON ECO power; 1-phase; 24 VDC output; 5 A output current).

In addition, in many cases with a similar building structure, a light switch has been placed in each case at the door of the nearest wall, at a height of 1.10 m and a distance of 0.09 m from the door frame. This light switch has been logically connected to an input of the 16-channel digital input assembly.

Such a specific sample pair made up of geometric features and features of the automation approach is generalized in a second step (step b). The geometric features as well as the associated features of automation approaches are hereby generalized to determine generalized geometric features and associated generalized features of automation approaches.

In the above example, it is possible that, for example, the exact dimensions, materials, or similar design details of the two windows with roller blinds, the door, the walls, and the suspended ceiling might not play a role in the automation approach to be planned. These details may therefore be omitted, wherein the geometric features or artifacts in this regard are generalized.

Furthermore, the exact types of features or artifacts of the automation engineering could remain undetermined in this phase of the automation planning. The generalized sample pair could then include, for example, only two SMI masters, a DALI master, two 16-channel digital inputs, a serial interface, and a network component without specifying their exact types. The exact types and specifications could be planned by the automation engineering planner at a later time.

In this way, a knowledge base made up of generalized sample pairs may be built which is the basis for automated basic planning of the automation engineering for the BIM.

To carry out automatic basic planning of the automation engineering for a building to be planned, the building information model, to be planned, of the building is analyzed for geometric features in a further step (step c) of the method. In the above example, the building information model is examined for windows and doors, suspended ceilings, and other geometric features.

The analyzed geometric features of the building information model to be planned are then compared to the generalized geometric features, and a comparison result is determined therefrom (step d). For example, in the building information model of the building to be planned, a search could be made for areas or segments in which two windows with roller blinds, a door, a wall, and a suspended ceiling are present. If this is the case, for this area the automation approach present in the knowledge base, with two SMI masters, a DALI master, two 16-channel digital inputs, a serial interface, and a network component, may be used.

For a positive comparison result, in a next step associated generalized features of automation approaches for the building information model 100 to be planned are included corresponding to the recognized geometric features. In the example, for the found segment of the software, the automation approach with two SMI masters, a DALI master, two 16-channel digital inputs, a serial interface, and a network component is included.

FIG. 2 shows a structure diagram of an example of software 1 for planning and setting up room and building automation approaches. The software 1 includes a loading module 10, a configuration module 20, a placement module 30, and a logic module 40. The software 1 may further include a publish module 50, a cloud module 60, a setup module 70, and a database 80 containing artifacts 104 and sample pairs.

The software 1 allows artifacts 104 of the building automation to be selected from the database 80 in the course of the building information modeling (BIM), configured by means of the configuration module 20, and placed in a 3D model 102 of the building information model 100 by means of the placement module 30. The artifacts 104 are instantiated. Logic for individual artifacts 104 or groups of artifacts 104 may be defined by means of the logic module 40. In addition, dependencies between the artifacts 104 may be defined by means of the logic module 40. The artifacts, the logic, and dependencies are incorporated into the building information model 100.

For carrying out the method according to the invention, the software 1 also includes an AI module 90 having a neural network, a cognitive machine, or a combination thereof. The AI module 90 includes an analysis module 92, a generalization module 94, a comparison module 96, and a planning module 98.

The analysis module 92 is configured to analyze existing building information models 100 for geometric features and associated features of automation approaches and to form specific sample pairs. In addition, the analysis module 92 is configured to analyze a building information model 100, to be planned, for geometric features.

The generalization module 94 is configured to generalize or abstract geometric features and the associated features of automation approaches in order to determine generalized geometric features and associated generalized features of automation approaches. From these, the generalization module 94 forms generalized sample pairs which are written into the database 80.

The comparison module 96 is configured to compare the analyzed geometric features of the building information model 100 to be planned to the generalized geometric features, and to determine a comparison result. The comparison result may be calculated as a percentage of agreement, which indicates the degree of agreement of the determined geometric segment with the corresponding generalized geometric features. The geometric features are not necessarily identified as semantic, completely described artifacts (as a door, window, or suspended ceiling, for example), and instead it is sufficient to recognize similar geometric structures as three-dimensional artifacts, and by evaluation of the arrangement, position information, and temporal change, to compare to the generalized planning results of the knowledge base.

If the agreement is sufficiently great, a positive comparison result is present and the generalized automation approach may be included in the building information model 100 by means of the planning module 98. For a positive comparison result, the planning module 98 is therefore configured to include associated generalized features of automation approaches for the building information model 100 to be planned, corresponding to the recognized geometric features.

The planning module 98 may enter the determined matching features of the automation approaches directly into the building information model 100. Alternatively, the planning module 98 may recommend the found matching features of the automation approaches to a user, so that the user can accept or reject the planning recommendation.

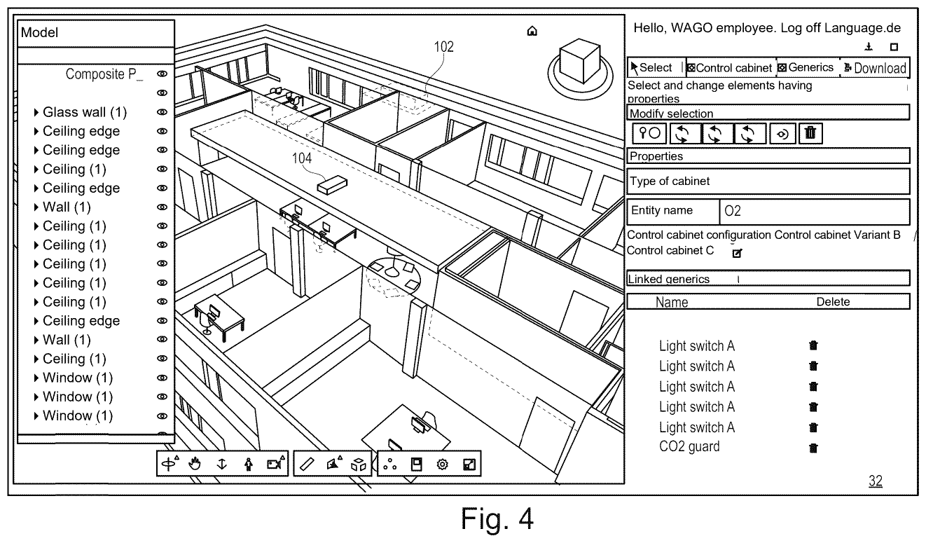

Furthermore, the planning module 98 may be configured so that upon acceptance of the recommended automation approaches, it transfers the user to the configuration module 20 so that the user may make a manual adjustment of the features of the automation approach. For example, the user may select the exact type of automation component and further configure it, as shown for a control cabinet 104 by way of example in FIG. 4.

For loading an existing building information model 100, the loading module, via a BIM manager 110, loads the appropriate data of the building information model 100 from a corresponding data source, as indicated by the arrows 112 and 12.

After planning of room and building automation approaches is completed, the planning results, in particular the artifacts, logic, and dependencies, are issued by a publish module 50 to the BIM manager 110, which adds them to the building information model 100. The data of the planning results are preferably published in IFC format.

Planning results for room and building automation are thus represented in the programming language of the Industry Foundation Classes (IFC) according to DIN EN ISO 16739, wherein in particular the modeling, not provided thus far, of logic and behavior of the artifacts in the building information model is possible. This allows later use of this logic and behavior in setting up specific embodiments of the artifacts 104 in the building 300.

For the further manual setup of embodiments of artifacts of the building automation 104 installed in a building 300, based on the logic and dependencies of the artifacts 104 stored in the building information model 100, the setup module 70 is used, which can communicate with the hardware installed in the actual building 300, as symbolized by the arrow 72.

For this purpose, the software 1 is designed as a cloud application, and can communicate with a cloud 200 via the cloud module 60, which also ensures location-independent use. Of course, the BIM manager 110 and the building information model 100 may likewise be present in a cloud.

The automation engineering planner who has logged in in his/her work area can view already loaded BIM models 100 of the building 300 or upload new BIM models 100. The data of the building 300 to be planned are preferably obtained in the digital exchange format (IFC, for example) by the loading module 10 and displayed to the automation engineering planner. For example, the planner may have the data of the building 102 displayed as a 3D model 120 or as a sectional 3D model 130, as illustrated in FIGS. 3A and 3B, respectively. However, at any time the planner may also use the placement module 30 to have any other desired views and presentation formats displayed, for example in planes or along individual axes. This represents the basis for starting the planning.

The planner may supplement the basic planning in a discipline-specific manner and create approaches for this building 300 according to requirements and tender documents. If multiple iterations of the planning result have been agreed to, after each iteration, or otherwise after conclusion of the planning process, the results of the automation engineering discipline with BIM relevance are transferred in IFC data format to the BIM manager 110.

The approaches of the room and building automation include, among other things, switch boxes and control cabinets, switches, illuminants, drives, sensors, and other artifacts 104. These must be configured according to the desired requirements for the room and building automation.

For this purpose, the individual artifacts 104 of the room and building automation are selected from a database 80 and instantiated. This takes place via the steps of configuring artifacts and placing the artifacts 104 by means of appropriate configuration masks.

In addition to the automatic basic planning by the software, the planner may also place artifacts 104 manually in the 3D model 102 of the building information model 100. The planner may thus select the most suitable view of the 3D model 102. FIG. 4 shows an example of the user interface 32 of the placement module 30 of the software 1 for the placement and configuration of an artifact control cabinet 104 at the ceiling of a room. The artifact 104 in the building information model 100 is instantiated by placement by means of the placement module 30. In addition to its configuration parameters and optionally dependencies and logic, the artifact preferably obtains a unique name or number (ID), and as an attribute, the location in the 3D model.

Since artifacts 104 are usually part of an approach, a connectedness relationship (as “part of” or “in a relationship with”) may also be modeled by means of the logic module. For example, switches connected to the control cabinet could be defined as “part of” or “in a relationship with” the control cabinet. In the example in FIG. 4, for example five switches of the type “light switch A” and a CO2 sensor (“CO2 guard”) are associated with the control cabinet.

All artifacts 104 that are instantiated from a preconfigured artifact class may be additionally designated so that they may be uniquely identified or searched.

After planning is completed, the planning result is transferred to the responsible BIM manager 100 by being issued in IFC format by the publish module 50, as illustrated by the example of the user interface 54 of the publish module 50 of the software 1. In addition, the publish module 50 can export the planning result in IFC format, locally store it, or send it as a file via email.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for planning and setting up room and building automation approaches, comprising the following steps that are carried out by software:
analyzing existing building information models for geometric features and associated features of automation approaches;
generalizing the geometric features and the associated features of automation approaches in order to determine generalized geometric features and associated generalized features of automation approaches;
analyzing a building information model, to be planned, for geometric features;
comparing the analyzed geometric features of the building information model to be planned to the generalized geometric features, and determining a comparison result; and
for a positive comparison result, including associated generalized features of automation approaches for the building information model to be planned, corresponding to the identified geometric features.

2. The method according to claim 1, wherein the software for carrying out the method includes a neural network, a cognitive machine, or a combination thereof.

3. The method according to claim 1, wherein the step of analyzing existing building information models for geometric features includes identification of a building structure.

4. The method according to claim 1, wherein the step of recognizing generalized geometric features in a building information model to be planned includes identification of a building structure.

5. The method according to claim 3, wherein the geometric features or the generalized geometric features include three-dimensional artifacts.

6. The method according to claim 1, wherein the building information models are created in standard Industry Foundation Classes (IFC).

7. The method according to claim 1, further comprising: downloading a stock configuration of an automation approach of an existing building.

8. The method according to claim 7, wherein for the downloading, hardware on which the software for carrying out the method runs is connected to one or more stock control devices of the existing building.

9. The method according to claim 1, further comprising:
recommending to a user the generalized features of automation approaches that are assigned to the building information model to be planned; and
accepting the recommended automation approach by the user.

10. The method according to claim 1, further comprising: manually adapting the features of the automation approach by the user.

11. The method according to claim 1, further comprising: exporting the supplemented building information model as an IFC model to a BIM manager.

12. The method according to claim 1, further comprising: setting up artifacts of the building automation that are installed in a building based on the configuration of artifacts that is included in the building information model.

13. Non-transitory computer-readable medium containing instructions for carrying out the method according to claim 1.
